(19) United States
(12) Patent Application Publication
(10) Pub. No.: US 2009/0198029 A1
(43) Pub. Date: Aug. 6, 2009

(54) N-VINYL CYCLIC LACTAM POLYMER, PRODUCTION METHOD THEREOF, AND APPLICATION THEREOF

(75) Inventors: Takahiro Tsumori, Hyogo (JP); Daisuke Imai, Osaka (JP); Yoshikazu Fujii, Kyoto (JP)

Correspondence Address: CONNOLLY BOVE LODGE & HUTZ LLP, 1875 EYE STREET, N.W., SUITE 1100, WASHINGTON, DC, 20006, US

(73) Assignee: Nippon Shokubai Co., Ltd, Osaka (JP)

(21) Appl. No.: 11/915,590

(22) PCT Filed: May 26, 2006
(86) PCT No.: PCT/JP2006/311043

§ 371 Date: Feb. 10, 2009

(30) Foreign Application Priority Data
May 27, 2005 (JP) 2005-156392

(51) Int. Cl. C08F 4/30; C08F 26/06

(52) U.S. Cl. 526/227; 526/264

(57) ABSTRACT

To provide: an N-vinyl cyclic lactam polymer, which has excellent dispersibility and adsorptivity, and high calcium-ion capturing capability and can be preferably used in, for example, a detergent additive application; an application thereof; and a production method of the N-vinyl cyclic lactam polymer, the production method being capable of efficiently producing such an N-vinyl cyclic lactam polymer. An N-vinyl cyclic lactam polymer produced by a polymerization of a monomer component containing a carboxyl group-containing unsaturated monomer with a polymer having an N-vinyl cyclic lactam unit, wherein the carboxyl group-containing unsaturated monomer is 200 to 9900 parts by weight, relative to 100 parts by weight of the polymer having an N-vinyl cyclic lactam unit, and the N-vinyl cyclic lactam polymer has a viscosity at 25° C. of 100000 mPa·s or less in an aqueous solution with a solid content of 25% by weight.

### TECHNICAL FIELD

The present invention relates to an N-vinyl cyclic lactam polymer, a production method thereof, and an application thereof. More preferably, the present invention relates to: an N-vinyl cyclic lactam polymer produced by using a polymer having an N-vinyl cyclic lactam unit, such as polyvinylpyrrolidone and polyvinylcaprolactam; a production method thereof; a detergent additive containing the polymer; and a detergent composition containing the polymer.

### BACKGROUND ART

Polymers having an N-vinyl cyclic lactam unit, such as polyvinylpyrrolidone and polyvinylcaprolactam, can exhibit excellent affinity, solubility, film-forming property, and the like to various substrates, because of the N-vinyl cyclic lactam structure. For example, a straight chain vinylpyrrolidone-acrylic acid random copolymer has been commercially available and use thereof in applications such as dispersants, adhesives, fiber-treatment agents has been proposed. However, this copolymer is a random, and therefore maybe insufficient in affinity of the N-vinylpyrrolidone cyclic depending on applications. In this point, this copolymer has room for improvement.

A technique for providing compatibility, adhesion, and the like by introducing a graft chain having a carboxyl group into a basic polymer has been publicly known. Various polymers having both properties exhibited by the N-vinyl cyclic lactam structure and the carboxyl group have been investigated using such a technique. For example, disclosed are an N-vinyl cyclic lactam graft polymer, in which a specific amount of unsaturated monomers containing carboxylic group are graft-polymerized to a basic polymer having an N-vinyl cyclic lactam unit and, which has a specified content of an impurity polymer (for example, referring to Japanese Kokai Publication No. 2001-278922, page 2), and a detergent additive containing an N-vinyl cyclic lactam grafted polymer, as an essential component, which is obtained by a graft copolymerization of a specific amount of a carboxylic group-containing unsaturated monomer on a substrate polymer having an N-vinyl cyclic lactam unit (for example, referring to Japanese Kokai Publication No. 2002-37820, page 2). Such grafted polymers are industrially very useful. However, such grafted polymers have room for improvement in order to be more useful in much more applications by further improvement in performances such as calcium ion-capturing capability.

### SUMMARY OF THE INVENTION

The present invention has been made in view of the above-mentioned state of the art. The present invention has an object to provide: an N-vinyl cyclic lactam polymer, which has excellent dispersibility and adsorptivity, and high calcium-ion capturing capability and can be preferably used in, for example, a detergent additive application; an application thereof; and a production method of the N-vinyl cyclic lactam polymer, the production method being capable of efficiently producing such an N-vinyl cyclic lactam polymer.

The present inventors have made various investigations about polymers having an N-vinyl cyclic lactam unit. They have noted that if a polymer having an N-vinyl cyclic lactam unit is polymerized with a monomer component containing a carboxyl group-containing unsaturated monomer, the obtained polymer is excellent in adsorptivity, dispersibility, and the like, because of the presence of the N-vinyl cyclic lactam structure and the carboxyl group. They have found that if the used amount of the carboxyl group-containing unsaturated monomer is specified at a certain amount and then the viscosity at 25° C. of the obtained polymer in an aqueous solution with a solid content of 25% by weight is specified, the dispersibility can be more improved, and the calcium-ion capturing capability can be sufficiently improved. They also have found that if such a polymer is used in, for example, a detergent additive application, such a polymer can prevent redeposition caused by clay soil and exhibit high detergency. Therefore, they have resolved the above-mentioned problems. They have also found that if a production method of such a polymer includes a step of performing the polymerization using a peroxide in combination with a chain transfer agent or a reducing agent, gelling can be sufficiently suppressed, and thereby the polymerization can be easily performed, leading to efficient production of the above-mentioned polymer. Thereby, the present invention has been completed.

That is, the present invention is an N-vinyl cyclic lactam polymer produced by a polymerization of a monomer component containing a carboxyl group-containing unsaturated monomer with a polymer having an N-vinyl cyclic lactam unit, wherein the carboxyl group-containing unsaturated monomer is 200 to 9900 parts by weight, relative to 100 parts by weight of the polymer having an N-vinyl cyclic lactam unit, and the N-vinyl cyclic lactam polymer has a viscosity at 25° C. of 100000 mPa·s or less in an aqueous solution with a solid content of 25% by weight.

The present invention is also a detergent additive containing the N-vinyl cyclic lactam polymer.

Further, the present invention is a detergent composition containing the detergent additive.

### DETAILED DESCRIPTION OF THE INVENTION

The present invention is described in more detail below.

The N-vinyl cyclic lactam polymer of the present invention is produced by polymerizing a monomer component containing a carboxyl group-containing unsaturated monomer with a polymer having an N-vinyl cyclic lactam unit. A graft polymerization of a monomer component containing a carboxyl group-containing unsaturated monomer with a basic polymer having an N-vinyl cyclic lactam unit is particularly preferably as a polymerization form, as mentioned below. Preferable embodiment of the present invention includes such a form, in which the above-mentioned N-vinyl cyclic lactam polymer is an N-vinyl cyclic lactam grafted polymer.

In the above-mentioned N-vinyl cyclic lactam polymer, the polymer having an N-vinyl cyclic lactam unit (hereinafter, also referred to as “polymer (A)”) is not especially limited as long as it has at least an N-vinyl cyclic lactam unit. For example, a homopolymer or a copolymer prepared by polymerizing or copolymerizing N-vinylpyrrolidone, N-vinylcaprolactam, and the like is preferred as such a polymer having an N-vinyl cyclic lactam unit. One or two or more species of the above-mentioned polymer (A) may be used.

The above-mentioned homopolymer is preferably polyvinylpyrrolidone and polyvinylcaprolactam, for example. More preferably, the above-mentioned homopolymer is polyvinylpyrrolidone with a number average molecular weight of 1000 to 3000000 and polyvinylcaprolactam with a number average molecular weight of 5000 to 500000.

In the above-mentioned copolymer, a monomer component copolymerized with N-vinylpyrrolidone, N-vinylcaprolactam, and the like, is not especially limited. Examples of the monomer component include (meth)acrylic esters, (meth)acrylic acids, maleates, maleic acids, N-vinylimidazoles, vinylpyridines, and olefins. One or two or more species of them may be used. Examples of the above-mentioned esters include alkyl esters containing 1 to 20 carbon atoms, dimethylaminoalkyl esters and quaternary salts thereof, and hydroxyalkyl esters. One or two or more species of monomers mentioned below as another monomer, which may be contained in the monomer component of the present invention, may be used as the monomer component in the above-mentioned copolymer.

The above-mentioned polymer (A) preferably has a number average molecular weight of 1000 to 3000000. Thereby, the polymerization can be performed efficiently and easily, and the obtained polymer can exhibit more sufficient dispersibility. If the number average molecular weight is less than 1000, the obtained polymer has an insufficient molecular weight, possibly failing to exhibit excellent dispersibility. If the number average molecular weight is more than 3000000, sufficiently uniform stirring may not be performed at the time of polymerization. More preferably, the lower limit of the number average molecular weight is 1500, and the upper limit thereof is 1000000. Still more preferably, the lower limit thereof is 2000, and the upper limit thereof is 100000.

The above-mentioned number average molecular weight can be determined by, for example, gel permeation chromatography (GPC) under the following conditions.

### <Measurement Condition of Number Average Molecular Weight (GPC Analysis)>

Column: produced by Showa Denko K. K., Shodex KD-G, Shodex LF804, Shodex KD801
Eluent: 0.1% by weight dimethylformamide solution of lithium bromide
Eluent flow rate: 0.8 mL/min
Injection volume: 10 μL
Column oven temperature: 40° C.
Detecting element: differential refractometer (RI)
Sample concentration: 0.5% by weight
Calibration curve: polystyrene conversion
Device: produced by Shimazu Corp.
System controller: SCL-10A
Auto injector: SIL-10A

### Pump: LC-10AD

Column oven: CTO-10A
RI detecting element: RID-6A

It is preferable that the above-mentioned polymer (A) has 20% by weight or more of the N-vinyl cyclic lactam unit derived from the N-vinylpyrrolidone, N-vinylcaprolactam, and the like, in 100% by weight of all the structural units. Thereby, the polymerization efficiency can be sufficiently improved. Therefore, byproduction of a polymer (impurity polymer) containing a carboxyl group-containing unsaturated monomer not being introduced into the above-mentioned polymer (A) as a chain can be sufficiently suppressed, which can improve the compatibility to various substrates. More preferably, the above-mentioned polymer (A) has 50% by weight or more of the N-vinyl cyclic lactam unit derived from the N-vinylpyrrolidone, N-vinylcaprolactam.

In the above-mentioned N-vinyl cyclic lactam polymer, it is preferable that a monomer component polymerized with the polymer (A) essentially contains a carboxyl group-containing unsaturated monomer. Thereby, the obtained polymer is provided with sufficient compatibility or adhesion, and a polymer excellent in various physical properties such as dispersibility and adsorbility can be obtained.

The above-mentioned carboxyl group-containing unsaturated monomer is not especially limited, and may be acrylic acids, methacrylic acids, maleic acids, fumaric acids, itaconic acids, and salts thereof, for example. One or two or more species of them may be used. Among them, acrylic acids, methacrylic acids, maleic acids, and salts thereof are preferred. Examples of the salts include alkali metal salts such as sodium and potassium, ammonium salts, and organic amine salts such as alkylamines and ethanolamines. Among them, alkali metal salts and ammonium salts are preferred.

The used amount of the above-mentioned carboxyl group-containing unsaturated monomer is 200 to 9900 parts by weight, relative to 100 parts by weight of the polymer (A). If the used amount is less than 200 parts by weight, the dispersibility is insufficient, and the calcium-ion capturing capability may be insufficient. If the used amount is more than 9900 parts by weight, the properties of the N-vinyl cyclic lactam unit constituting the polymer (A) is insufficiently exhibited, which makes it impossible to further enhance the utility in applications. More preferably, the lower limit of the used amount is 300 parts by weight, and the upper limit thereof is 5000 parts by weight. Still more preferably, the lower limit thereof is 350 parts by weight, and the upper limit thereof is 2000 parts by weight.

If a salt form of the above-mentioned carboxyl group-containing unsaturated monomer is used, the above-mentioned ratio by weight is calculated as a value calculated by converting the salt into an acid forming the salt. That is, if sodium acrylate is used, for example, the sodium acrylate is converted into acrylic acid, and then the above-mentioned ratio by weight is calculated.

The content of the carboxyl group-containing unsaturated monomer in 100% by weight of all the monomer components is preferably 25% by weight or more, for example. The content is more preferably 40% by weight or more, and particularly preferably 60% by weight or more, and most preferably 100% by weight.

The above-mentioned monomer component may contain, if necessary, another monomer other than the carboxyl group-containing unsaturated monomer. The another monomer is not especially limited as long as it is copolymerizable with the carboxyl group-containing unsaturated monomer. Examples of the another monomer include N-vinylacetamides, N-vinylformamides, N-vinylpyrrolidones, N-vinylcaprolactams, N-vinyl imidazoles, vinylpyridines, alkyl vinyl ethers, (meth)acrylic esters, (meth)acrylic acids, maleates, maleic acids, and olefins. One or two or more species of them may be used. Examples of the above-mentioned (meth)acrylic esters include alkyl esters containing 1 to 20 carbon atoms, dimethylaminoalkyl esters and quaternary salts thereof, and hydroxyalkyl esters. One or two or more species of them may be used.

One or two or more species of the following monomers may be also used as the above-mentioned another monomer: functional group-containing monomers, for example, amide group-containing monomers such as (meth)acrylamide and (meth)acryl acetylamide; vinyl esters such as vinyl acetate, vinyl propionate, vinyl pivalate, vinyl benzoate, and vinyl cinnamic acid; alkene monomers such as ethylene and propylene; aromatic vinyl monomers such as styrene and styrene sultonic acid; trialkyloxysilyl group-containing vinyl monomers such as vinyltrimethoxysilane and vinylethoxysilane; silicon-containing vinyl monomers such as γ-(methacryloyloxypropyl)trimethoxysilane; maleimide derivatives such as maleimide, methylmaleimide, ethylmaleimide, propylmaleimide, butylmaleimide, octylmaleimide, dodecylmaleimide, stearylmaleimide, phenylmaleimide, and cyclohexylmaleimide; nitrile group-containing vinyl monomers such as (meth)acrylonitrile; aldehyde group-containing vinyl monomers such as (meth)acrolein; sulfonic acid group-containing monomers such as 2-acrylamide-2-methylpropane sulfonic acid (salt), (meth)allyl sulfonic acid (salt), vinyl sulfonic acid (salt), styrene sulfonic acid (salt), 2-hydroxy-3-butene sulfonic acid (salt), and sulfoethyl (meth)acrylate; hydroxyalkyl (meth)acrylate compounds such as hydroxyethyl (meth)acrylate and hydroxypropyl (meth)acrylate; alkyl vinyl ethers such as methyl vinyl ether and ethyl vinyl ether; vinyl chloride, vinylidene chloride, allyl chloride, and allyl alcohol; 3-methyl-3-butene-1-ol; 3-methyl-2-butene-1-ol; polyalkylene oxide adducts of 2-methyl-3-butene-2-ol and alcohols thereof; 3-(meth)acryloxy-1,2-dihydroxypropane; 3-(meth)acryloxy-1,2-di(poly)oxyethylene ether propane; 3-(meth)acryloxy-1,2-di(poly)oxypropylene ether propane; 3-(meth)acryloxy-1,2-dihydroxypropane phosphate, and monovalent metal salts thereof, bivalent metal salts thereof, ammonium salts thereof, organic amine salts thereof, or, monoesters or diesters of an alkyl group containing 1 to 4 carbon atoms; 3-(meth)acryloxy-1,2-dihydroxypropane sulfate and monovalent metal salts thereof, bivalent metal salts thereof, ammonium salts thereof, organic amine salts thereof, or esters of an alkyl group containing 1 to 4 carbon atoms; 3-(meth)acryloxy-2-hydroxypropane sulfonic acid and monovalent metal salts thereof, bivalent metal salts thereof, ammonium salts thereof, organic amine salts thereof, or esters of an alkyl group containing 1 to 4 carbon atoms; 3-(meth)acryloxy-2-(poly)oxyethylene ether propane sulfonic acid and monovalent metal salts thereof, bivalent metal salts thereof, ammonium salts thereof, organic amine salts thereof, or esters of an alkyl group containing 1 to 4 carbon atoms;

3-(meth)acryloxy-2-(poly)oxypropylene ether propane sulfonic acid and monovalent metal salts thereof, bivalent metal salts thereof, ammonium salts thereof, organic amine salts thereof, or esters of an alkyl group containing 1 to 4 carbon atoms; 3-allyloxypropane-1,2-diol; 3-allyloxypropane-1,2-diol phosphate; 3-allyloxylpropane-1,2-diol sulfonate; 3-allyloxypropane-1,2-diol sulfate; 3-allyloxy-1,2-di(poly)oxyethylene ether propane; 3-allyloxy-1,2-di (poly)oxyetheylene ether propane phosphate; 3-allyloxy-1,2-di(poly oxyethylene ether propanesulfonate; 3-allyloxy-1,2-di(poly)oxypropylene ether propane; 3-allyloxy-1,2-di(poly)oxypropylene ether propane phosphate; 3-allyloxy-1,2-di(poly)oxypropylene ether propanesulfonate; 6-allyloxyhexane-1,2,3,4,5-pentaol; 6-allyloxyhexane-1,2,3,4,5-pentaol phosphate; 6-allyloxyhexane-1,2,3,4,5-pentaol sulfonate; 6-allyloxyhexane-1,2,3,4,5-penta(poly)oxyethylene ether hexane; 6-allyloxyhexane-1,2,3,4,5-penta(poly)oxypropylene ether hexane; 3-allyloxy-2-hydroxypropane sulfonic acid and monovalent metal salts thereof, bivalent metal salts thereof, ammonium salts thereof, or organic amine salts thereof, or, phosphate esters or sulfuric esters of these compounds and monovalent metal salts thereof, bivalent metal salts thereof, ammonium salts thereof, or organic amine salts thereof; 3-allyloxy-2-(poly)oxyethylene propane sulfonic acid and monovalent metal salts thereof, bivalent metal salts thereof, ammonium salts thereof, or organic amine salts thereof, or, phosphate esters or sulfuric esters of these compounds and monovalent metal salts thereof, bivalent metal salts thereof, ammonium salts thereof, or organic amine salts thereof; 3-allyloxy-2-(poly)oxypropylene propane sulfonic acid and monovalent metal salts thereof, bivalent metal salts thereof, ammonium salts thereof, or organic amine salts thereof, or, phosphate esters or sulfuric esters of these compounds and monovalent metal salts thereof, bivalent metal salts thereof, ammonium salts thereof, or organic amine salts thereof.

It is preferable that the N-vinyl cyclic lactam polymer of the present invention is not a gelled polymer and has a viscosity at 25° C. of 100000 mPa·s or less in an aqueous solution with a solid content of 25% by weight. If the viscosity is more than 100000 mPa·s, the polymer may contain gelled substances, and therefore can not exhibit sufficient hydrophilicity or dispersibility, possibly failing to be used preferably in various applications. The viscosity is preferably 50000 mPa·s, and more preferably 30000 mpa·s.

The above-mentioned viscosity at 25° C. can be determined by the following way, for example.

<Determination of Viscosity at 25° C. in an Aqueous Solution with a Solid Content of 25% by Weight>

Into a 200 mL of beaker is added an aqueous solution with a solid content of 25% by weight (an aqueous solution containing 25% by weight of the polymer on solid content equivalent basis) 200 g, and the aqueous solution is measured for viscosity at 25° C. using a spindle of #1 to #4 of a viscometer (produced by Brookfield Engineering Laboratories; LVDL-I+).

The above-mentioned N-vinyl cyclic lactam polymer is preferably a grafted polymer, as mentioned above, for improvement in anti-soil redeposition ratio. Such a grafted N-vinyl cyclic lactam polymer is preferable because turbidity and generation of separation in the polymer can be more sufficiently suppressed, and thereby a uniform aqueous solution can be prepared. Therefore, a kaolin turbidity is preferably 200 mg/L or less. Thereby, a uniform aqueous solution not separating under long term-preservation can be obtained, and such an aqueous solution can be preferably used in various applications. The kaolin turbidity is more preferably 100 mg/L or less, and still more preferably 50 mg/L or less.

The above-mentioned kaolin turbidity can be determined by the following way, for example.

### <Determination of Kaoline Turbidity>

Into a 50 mm square cell of 10 mm thickness is charged a uniformly stirred aqueous solution with a solid content of 25% by weight (an aqueous solution containing 25% by weight of the polymer on solid content equivalent basis), and bubbles are removed therefrom. Then, the solution is measured for turbidity (kaolin turbidity: mg/L) at 25° C. using NDH2000 (trade name, turbidimeter) produced by Nippon Denshoku Industries Co., Ltd.

The above-mentioned N-vinyl cyclic lactam polymer preferably has a calcium ion-capturing capability of 230 mg·CaCO₃/g or more. Such a polymer can preferably function to various water systems. If such a polymer is used in a detergent additive application, the detergent can exhibit stronger detergency. The calcium ion-capturing capability is more preferably 240 mg·CaCo₃/g or more, and still more preferably 250 mg·CaCo₃/g or more.

The above-mentioned calcium ion-capturing capability can be determined by the following way, for example.

### <Determination of Calcium Ion-Capturing Capability>

A sample solution for calibration curve is prepared by: preparing aqueous solutions 50 g of 0.01 mol/L, 0.001 mol/L, and 0.0001 mol/L, using calcium chloride dihydrate as a calcium ion standard solution for calibration curve; adjusting such aqueous solutions to pH 9.9 to 10.2 with a 1.0% by weight aqueous solution of NaOH; further adding 1 mL of a potassium chloride aqueous solution of 4 mol/L (hereinafter, abbreviated as “4M-KCl aqueous solution”) into the aqueous solutions; and stirring the mixture enough with a magnetic stirrer. Similarly using calcium chloride dihydrate as a calcium ion standard solution for test, a needed amount of (50 g per sample) an aqueous solution of 0.001 mol/L is prepared. Then, a test sample (polymer) 10 mg on solid content equivalent basis is weighted and put into a 100 cc beaker, and thereto is added the above-mentioned calcium ion standard solution for test 50 g. The mixture is stirred enough with a magnetic stirrer. A polymer used as the test sample is neutralized with a 48% by weight aqueous solution of sodium hydroxide such that pH is 7.5 when the solid content is 40% by weight, to be used. Then, a sample solution for test is prepared in the same manner as in preparation of the sample solution for calibration curve, by adjusting the above aqueous solutions to pH 9.9 to 10.2 with a 1.0% by weight aqueous solution of NaOH and adding 1 mL of 4M-KCl aqueous solution.

The thus-prepared sample solution for calibration curve and sample solution for test are measured by calcium ion electrode 93-20 and reference electrode 90-01 produced by Orion Corp., using a titrator COMTITE-550 produced by Hiranuma Sangyo Co., Ltd.

It is preferable that the above-mentioned N-vinyl cyclic lactam polymer has an anti-soil redeposition ratio of 65.0% or more. More preferably, the anti-soil redeposition ratio is 66.0% or more.

The “anti-soil redeposition ratio” is an indicator of performance of preventing redeposition caused by clay soil, and can be determined by the following way, for example.

### <Determination of Anti-Soil Redeposition Ratio>

(1) A cotton cloth according to JIS L0803:1998 is cut into 5 cm×5cm to prepare 10 sheets of white clothes. Whiteness (z value) of each of the white clothes is previously measured as a reflectance using a colorimetric difference meter (produced by Nippon Denshoku Industries Co., Ltd., ND-1001DP type). The average value of the refrectances is defined as “AO”. When the whiteness is measured, a cloth to be measured is covered with the rest 9 sheets of white clothes (on the opposite side to the measurement side), and thereon, 10 sheets of cotton white clothes (product of Cleaning Science Association Foundation) are placed.

(2) Pure water is added to 2.21 g of calcium chloride dihydrate to prepare 15 kg of hard water. Then, this hard water is bathed into an incubator at 25° C.

(3) A targotmeter is set at 25° C., and hard water 1 L and a clay (JIS test dust Class 11 obtained from The Association of Powder Process Industry and Engineering) 0.5 g are put in a pot and the mixture is stirred at 100 rpm for 1 minute. Thereto are put 10 sheets of white clothes and stirring is performed at 100 rpm for 1 minute.

(4) Further, into the above-mentioned pot is added a 5% by weight aqueous solution of sodium carbonate 4 g, a 5% by weight aqueous solution of straight chain alkylbenzene sulfonic acid (LAS) 4 g, synthetic zeolite A-4 (average particle size of 2 to 5 μm) 0.15 g, and a 1% by weight aqueous solution (on solid content equivalent basis) of test polymer (N-vinyl cyclic lactam polymer) 5 g, and stirring is performed at 100 rpm for 10 minutes.

(5) The white clothes are wringed by hand, and 1 L of the above-hard water kept at 25° C. is put in a pot and stirring is performed at 100 rpm for 2 minutes. This operation is repeated two times.

(6) Operations of the above (3) to (5) are repeated three times.

(7) The 10 sheets of white clothes are each pressed with a filler cloth to dry them while smoothing wrinkles. Whiteness (Zvalue) of each of the white clothes is measured as a reflectance again using the above-mentioned calorimetric difference meter. The average of the reflectances is defined as “A1”.

(8) The anti-soil redeposition ratio is determined by applying the above-calculated “A0” and “A1” to the following formula: Anti-soil redeposition rate (%)=(A1)/(A0)×100. The higher the obtained value is, the more excellent the anti-soil redeposition ratio is.

Further, the above-mentioned N-vinyl cyclic lactam polymer preferably has a content of an impurity polymer of 40% by weight or less. Thereby, the compatibility to various substrates, and the like can be enhanced, and the reactivity of the carboxyl group in the polymer can be sufficiently improved. Therefore, such a polymer can be more preferably used in an application utilizing the reactivity of the carboxyl group. The content of an impurity polymer is more preferably 30% by weight or less, and still more preferably 20% by weight or less.

The “impurity polymer” means a polymer containing a carboxyl group-containing unsaturated monomer not being introduced into the polymer (A) as the chain. The content of the impurity polymer is a content (% by weight) of the impurity polymer in 100% by weight of N-vinyl cyclic lactam polymer.

The N-vinyl cyclic lactam polymer of the present invention can be produced by polymerizing the monomer component containing the carboxyl group-containing unsaturated monomer with the polymer (A) in the presence of an initiator. Among them, it is particularly preferable that the polymerization is performed using, as the initiator, a peroxide in combination with a chain transfer agent or a reducing agent. Thereby, gelling can be sufficiently suppressed, and thereby the polymerization can be performed efficiently and easily. The present invention includes a production method of the N-vinyl cyclic lactam polymer, wherein the production method comprises a step of performing the polymerization using a peroxide in combination with a chain transfer agent or a reducing agent. Preferred is a graft polymerization of the monomer component containing the carboxyl group-containing unsaturated monomer with the basic polymer having the N-vinyl cyclic lactam unit, as a polymerization form. Thereby, the anti-soil redeposition ratio of the obtained N-vinyl cyclic lactam polymer can be further improved.

A great amount of the carboxyl group-containing unsaturated monomer is used in view of improvement in dispersibility, calcium-ion capturing capability and the like, in the present invention. Therefore, if the polymerization is performed using conventional polymerization methods, the polymerization may be difficult because of generation of gelled substances during the polymerization. However, the simultaneous use of the peroxide and the chain transfer agent or the reducing agent makes it possible to sufficiently suppress the gelling and thereby perform the polymerization easily, even if a great amount of the carboxyl group-containing unsaturated monomer is used. Thereby, the above-mentioned polymer excellent in various performances can be produced with high efficiency.

At least three species of the peroxide, the transfer agent and the reducing agent can be simultaneously used as the initiator.

In the above-mentioned polymerization step, the method of the polymerization reaction is not especially limited. For example, the polymerization reaction may be performed by conventional polymerization methods such as solution polymerization, emulsion polymerization, suspension polymerization, and precipitation polymerization. Among them, the polymerization reaction is preferably performed by solution polymerization.

The above-mentioned polymer (A) maybe charged in one step initially or added sequentially, and preferably charged in one step initially in view of shortening of the reaction time, improvement in the productivity, and the like. The monomer component such as the carboxyl group-containing unsaturated monomer is preferably added sequentially in view of the polymerization efficiency, the reaction control, and the like, but the way of the addition is not limited thereto. The monomer component may be charged in one step initially. The monomer component such as the carboxyl group-containing unsaturated monomer may be previously diluted with a solvent mentioned below and then added.

In the above-mentioned polymerization step, examples of the peroxide include persulfates such as ammonium persulfate, sodium persulfate, and potassium persulfate; hydrogen peroxides; ketone peroxides such as methyl ethyl ketone peroxide and cyclohexanone peroxide; hydroperoxides such as t-butyl hydroperoxide, cumene hydroperoxide, diisopropyl benzene hydroperoxide, p-menthane hydroperoxide, 2,5-dimethyl hexane-2,5-dihydroperoxide, and 1,1,3,3-tetramethylbutyl hydroperoxide; dialkyl peroxides such as di-t-butyl peroxide, t-butyl cumyl peroxide, dicumyl peroxide, and α,α′-bis(t-butylperoxide)p-diisopropyl hexyne; peroxyesters such as t-butyl peroxyacetate, t-butyl peroxylaurate, t-butyl peroxybenzoate, di-t-butyl peroxyisophthalate, 2,5-dimethyl-2,5-di(benzoyl peroxy)hexane, and t-butylperoxyisopropyl carbonate; peroxy ketals such as n-butyl-4,4-bis(t-butylperoxy)valerate and 2,2-bis(t-butylperoxy)butane; and diacyl peroxides such as dibenzoyl peroxide. One or two or more species of them may be used.

Conventionally used chain transfers may be used as the above-mentioned chain transfer. Examples of the chain transfer include:

hydrophilic chain transfer agents, for example, thiol chain transfer agents such as mercaptoethanol, thioglycerol, thioglycolic acid, 3-mercaptopropionic acid, thiomalic acid, and 2-mercaptoethanesulfonic acid; secondary alcohols such as isopropyl alcohol; and lower oxides and salts thereof such as phosphorous acids, phosphinic acids and salts thereof (sodium hypophosphite, phosphinic acid potassium, and the like), sulfurous acids, hydrogen sulfites, dithionic acids, and metabisulfurous acids and salts thereof (sodium sulfite, sodium hydrogensulfite, sodium dithionite, sodium metabisulfite, and the like); and

hydrophobic chain transfer agents, for example, thiol chain transfer agents having a hydrocarbon group containing 3 or more of carbon atoms such as butane thiol, octane thiol, decan thiol, dodecane thiol, hexadecane thiol, octadecane thiol, cyclohexyl mercaptan, thiophenol, thioglycolic acid octyl, and 3-mercaptopropionic acid octyl. One or two or more species of them may be used.

The above-mentioned reducing agent may be conventionally used reducing agents, and is not especially limited. Examples of the reducing agent include iron(II) salts, dithionites, bisulfites (hydrogensulfites), sulfites, thiosulfates, sodium formaldehyde sulfoxylates, and ascorbic acids. One or two or more species of them may be used. Among them, bisulfites are particularly preferably used.

Salts of metal atoms, ammoniums, or organic ammoniums are preferred as dithionites, bisulfites, sulfites, and thiosulfates. Preferred examples of the metal atoms include monovalent metal atoms of alkali metals such as lithium, sodium, and potassium; bivalent metal atoms of alkaline earth metals such as calcium and magnesium; trivalent metal atoms such as aluminium and iron. The organic ammoniums (organic amines) are preferably alkanolamines such as ethanolamine, diethanolamine, and triethanolamine, and triethylamine. Further, ammoniums may be preferable. Among them, sodium salts are preferred.

With respect to the ratio by weight of the peroxide to the chain transfer agent and/or the reducing agent in the above-mentioned polymerization step, for example, the lower limit of the chain transfer agent and/or the reducing agent is 0.01 parts by weight, and the upper limit thereof is 10 parts by weight, relative to 100 parts by weight of the peroxide. If the ratio by weight of the chain transfer agent and/or the reducing agent is less than 0.01 parts by weight, gelling may be insufficiently suppressed. If the ratio by weight thereof is more than 10 parts by weight, the production method may not be economically excellent. More preferably, the lower limit thereof is 0.05 parts by weight, and the upper limit thereof is 5 parts by weight. Still more preferably, the lower limit is 0.1 parts by weight, and the upper limit thereof is 3 parts by weight.

The total used amount of the peroxide, the chain transfer agent and/or the reducing agent is not especially limited. For example, the total used amount thereof is 0.1 to 30 parts by weight to 100 parts by weight of all the monomer components used in the polymerization. If the total used amount thereof is less than 0.1 parts by weight, the polymerization degree to the polymer (A) is insufficient, which may make it impossible to sufficiently suppress the amount of the byproduction of the impurity polymer. If the total used amount thereof is more than 30 parts by weight, the production method may not be economically excellent. The total amount thereof is more preferably 0.5 to 20 parts by weight.

Another initiator conventionally used, other than the above-mentioned initiators, may be used as the initiator in the above-mentioned polymerization step. In this case, the another initiator is preferably 20% by weight or less in 100% by weight of the total amount of the initiator. More preferably, the another initiator is 10% by weight or less.

The way of the addition of the above-mentioned initiator is not especially limited. The initiator may be charged in one step initially, or added dropwise, or added successively, for example, in portions. The initiator may be singly introduced into a reaction container, or may be previously mixed with the polymer (A), the monomer component, the solvent, and the like.

A more preferable embodiment in the above-mentioned polymerization step is a step using at least the peroxide in combination with a bisulfite as the initiator. Thereby, gelling can be sufficiently suppressed. Therefore, functional effects of the present invention can be preferably exhibited, that is, the above-mentioned polymer excellent in various performances can be produced with high efficiency. As mentioned above, an embodiment, in which the polymerization step is a step of using the peroxide in combination with a bisulfite, is part of preferable embodiment of the present invention.

Salts of metal atoms, ammoniums, or organic ammoniums are preferable as the above-mentioned bisulfite, as mentioned above. More preferred are sodium salts, that is, sodium hydrogensulfites.

A solvent may be used in the above-mentioned polymerization. The solvent is not especially limited as long as the polymer (A) is dissolved. Examples of the solvent include water; alcohols; ethers; ketones; esters; amides; sulfoxides; and hydrocarbons. These may be used singly or in combination of two or more species of them. Among them, preferred are water, methyl alcohol, ethyl alcohol, n-propyl alcohol, isopropyl alcohol, t-butyl alcohol, methyl cellosolve, ethyl cellosolve, butyl cellosolve, acetone, methyl ethyl ketone, tetrahydrofuran, 1,4-dioxane, 1,3-dioxolane, toluene, ethyl acetate, and mixed solvents thereof. Water is particularly preferable. These solvent may contain organic amines, ammonia, and the like for neutralization of the carboxylic acid or pH control. An alkali metal hydroxide may be used in a solvent containing water.

The used amount of the above-mentioned solvent is not especially limited, and preferably set such that the polymerization concentration is within a preferable range mentioned below. Specifically, the used amount of the solvent is preferably 5 to 900 parts by weight, relative to 100 parts by weight of the polymer (A). The used amount of the solvent is more preferably 25 to 400 parts by weight. The above-mentioned solvent may be charged in one step initially, or added sequentially.

With respect to reaction conditions at the above-mentioned polymerization, the reaction temperature is not especially limited, and preferably 0 to 200° C., and more preferably 50 to 150° C. The reaction pressure is not especially limited, and the reaction may be performed under ordinary pressure (atmospheric pressure), reduced pressure, or pressurization. A reaction performed while the solvent is boiled under ordinary pressure or reduced pressure is preferable because cooling can be effectively performed and thereby the reaction control can be easier. Further, the above-mentioned polymerization is preferably performed under inert gas atmospheres such as nitrogen gas, argon gas, and CO₂ gas. However, the condition is not especially limited to the above.

In the above-mentioned polymerization, the polymerization concentration is preferably 20% by weight or more. Thereby, the polymerization efficiency is improved and a concentration step and the like can be omitted or simplified. Therefore, the productivity is significantly improved, which permits sufficient reduction in production costs. The polymerization concentration is more preferably 25% by weight or more and still more preferably 30% by weight or more. In the present invention, the simultaneous use of the peroxide and the chain transfer agent or the reducing agent makes it possible to produce the above-mentioned polymer more easily and more efficiently even under such a high concentration condition, as mentioned above.

The above-mentioned “polymerization concentration” means a concentration of the solid content in the solution, that is, a concentration of the solid content in the polymerization reaction system (for example, the content of the polymer solid content of the monomer) upon termination of the polymerization reaction. The “upon termination of the polymerization reaction” may be after termination of each dropwise addition of the above-mentioned components. More specifically, it may be after the reaction solution into which each of the above-mentioned components has been added dropwise is maintained (matured).

As mentioned above, use of the above-mentioned production method permits an efficient production of the N-vinyl cyclic lactam polymer of the present invention. In particular, if the polymerization step is a step of using the peroxide in combination with the bisulfites, the production efficiency is further improved, and the functional effects attributed to the polymer can be more sufficiently exhibited. Such a production method is also preferable as the following production method of the polymer.

That is, the present invention includes a production method of an N-vinyl cyclic lactam polymer produced by a polymerization of a monomer component containing a carboxyl group-containing unsaturated monomer with a polymer having an N-vinyl cyclic lactam unit, wherein the production method comprises a step of performing the polymerization using a peroxide in combination with a bisulfite.

Preferred embodiment, various conditions, and the like in the polymerization step of such a production method are preferably as mentioned above.

One or two or more species of conventionally used polymers having an N-vinyl cyclic lactam unit may be used as the polymer having an N-vinyl cyclic lactam unit used in the above-mentioned production method. Preferable form of such a polymer may be the form mentioned above.

The used amount of the carboxyl group-containing unsaturated monomer in the above-mentioned monomer component is preferably set as mentioned above. The above-mentioned monomer component may contain another monomer other than the carboxyl group-containing unsaturated monomer. Preferable embodiments of the another monomer, the used amount, and the like may be the above-mentioned embodiments.

The N-vinyl cyclic lactam polymer of the present invention has excellent dispersibility and adsorptivity, high calcium ion-capturing capability, and excellent various performances. For example, such an N-vinyl cyclic lactam polymer can be used in various applications such as detergent additive, dispersant for various inorganic or organic substance, thickener, cohesive agent, adhesive agent, surface-coating agent, and cross linking agent. More specifically, such an N-vinyl cyclic lactam polymer can be preferably used in scale inhibitor, mud dispersant, cement material dispersant, cement material separation reducing agent, thickener for cement materials, flocculant, detergent builder, dye transfer inhibitor for detergents, heavy metal scavenger, metal surface treatment, dyeing assistant, dye fixing agent, foam stabilizer, emulsion stabilizer, ink dye dispersing agent, water-based ink stabilizer, pigment agent for coating materials, thickener for coating materials, pressure sensitive adhesive, paper adhesive, adhesive for medical use, adhesive for patches, stick paste, adhesive for face packs, filler dispersant for resins, coating agent for recording papers, finishing agent for inkjet papers, dispersant for photosensitive resins, antistatic agent, moisturizer, raw material for water-absorbing resins, binder for fertilizers, polymer cross linking agent, resin compatibilizer, photographic additive, cosmetic dispensing additive, hairdressing assistant, hair spray additive, and sunscreen composition additive. Among them, the N-vinyl cyclic lactam polymer is preferably used in a detergent additive. Such a detergent additive containing the N-vinyl cyclic lactam polymer is part of the present invention.

The above-mentioned detergent additive contains the above-mentioned N-vinyl cyclic lactam polymer of the present invention. Such a detergent additive can effectively prevent migration to other fibers because the N-vinyl cyclic lactam structure and the carboxyl group of the polymer adsorb to dye, which elutes into water from a fiber during washing, and then disperse it. Also, such a detergent additive can sufficiently prevent redeposition due to clay soil as mentioned above, and thereby can sufficiently exhibit high detergency.

In such a detergent additive, the content ratio of the N-vinyl cyclic lactam polymer of the present invention is preferably 1 to 100% by weight and more preferably 20 to 100% by weight in 100% by weight of the solid content of the detergent additive.

The detergent additive of the present invention can be blended to, for example, domestic powder detergents, liquid detergents, softening agents, industrial cleaning agents, and fiber treatments, to be used. The blended amount of the detergent additive in such a case is not especially limited. For example, the blended amount of the detergent additive is preferably set to 0.05to20%by weight, and more preferably 0.1 to 10% by weight in 100% by weight of domestic powder detergents, liquid detergents, softening agents, industrial cleaning agents, or fiber treatments.

Various blended substrates such as domestic powder detergents, liquid detergents, softening agents, industrial cleaning agents, and fiber treatments may contain acrylic acid polymers or acrylic acid/maleic acid copolymers conventionally used as a detergent additive.

The above-mentioned detergent additive is blended to a detergent and then used, as a particularly preferable embodiment of the above-mentioned detergent additive. Thereby, the functional effects of the present invention are sufficiently exhibited, that is, such a detergent additive can sufficiently prevent the migration and the redeposition due to the clay soil and thereby exhibit high detergency. As mentioned above, a detergent composition (detergent) containing the detergent additive is part of the present invention.

With respect to the content ratio of the detergent additive of the present invention in the above-mentioned detergent composition, for example, the content ratio of the above-mentioned N-vinyl cyclic lactam polymer is preferably set to 0.1 to 40% by weight in 100% by weight of the detergent composition. If the content ratio is less than 0.1% by weight, the detergent composition may exhibit insufficient detergent performance. If the content ratio is more than 40% by weight, the detergent composition may not be economically excellent. The content ratio is more preferably 0.2 to 30% by weight.

The form of the above-mentioned detergent composition is not especially limited, and may be in powder or liquid form.

The above-mentioned detergent composition preferably contains a surfactant in addition to the above-mentioned detergent additive. Examples of such a surfactant include anionic surfactants, nonionic surfactants, cationic surfactants, and amphoteric surfactants. One or two or more species of them may be used.

Examples of the above-mentioned anionic surfactants include alkylbenzene sulfonates, alkyl or alkenyl ether sulfates, alkyl or alkenyl sulfates, α-olefin sulfonates, α-sulfofatty acids or ester salts thereof, alkane sulfonates, saturated or unsaturated fatty acid salts, alkyl or alkenyl ether carboxylates, amino acid surfactants, N-acylamino acid surfactants, and, alkyl or alkenyl phosphate or salts thereof. The alkyl group or the alkenyl group of such anionic surfactants may have a branched structure of the alkyl group such as a methyl group.

Examples of the above-mentioned nonionic surfactants include polyoxyalkylene alkyl or alkenyl ethers, polyoxyethylene alkyl phenyl ethers, higher fatty acid alkanol amides or alkylene oxide adducts thereof, sucrose fatty acid esters, alkyl glycoxides, fatty acid glycerin monoesters, and alkylamine oxides. The alkyl group or the alkenyl group of such nonionic surfactants may have a branched structure of the alkyl group such as a methyl group.

Quarternary ammonium salts and the like may be mentioned as the above-mentioned cationic surfactants. Carboxyl type or sulfobetaine type amphoteric surfactants may be mentioned as the above-mentioned amphoteric surfactants.

The content ratio of the surfactant in the above-mentioned detergent composition is preferably 1 to 70% by weight in 100% by weight of the detergent composition. If the content ratio is less than 1% by weight, the detergent composition may insufficiently exhibit detergent performances. If the content ratio is more than 60% by weight, the detergent composition may not be economically excellent. The content ratio is more preferably 15 to 60% by weight.

The above-mentioned detergent composition preferably contains a detergent builder. The content ratio of the detergent builder in this case is preferably 0.1 to 60% by weight in 100% by weight of the detergent composition, for example. More preferably, the content ratio is 1 to 10% by weight if the detergent composition of the present invention is supplied in liquid state, and the content ratio is 1 to 50% by weight if the detergent composition of the present invention is supplied in powder state.

The above-mentioned detergent builder is not especially limited. Examples of the detergent builder include organic builders such as alkali metal salts, ammonium salts, substituted ammonium polyacetates, carboxylates, polycarboxylates, and polyhydroxy sulfonates; inorganic builders such as silicates, aluminosilicates, borates, and carbonates. One or two or more species of them may be used.

Examples of polyacetates or polycarboxylates in the above-mentioned organic builders include sodium salts, potassium salts, ammonium salts, substituted ammonium salts of ethylenediaminetetraacetic acids, nitrilotriacetic acids, oxydisuccinic acids, mellitic acids, glycolic acids, benzene polycarboxylic acids and citric acids.

Preferred examples of the above-mentioned inorganic builders include: sodium salts or potassium salts of carbonic acids, bicarbonic acids, and silicic acids; and aluminosilicates such as zeolites.

The above-mentioned detergent composition may further contain conventionally used additives or solvents such as dye transfer inhibitor, fluorescent whitening agent, foaming agent, foam inhibitor, anticorrosive, antirust, soil suspension, soil release agent, pH adjustor, fungicide, chelating agent, viscosity modifier, enzyme, enzyme stabilizer, perfume, fiber softener, peroxide, peroxide stabilizer, fluorescence agent, coloring agent, foam stabilizer, lustering agent, bleaching agent, and dye. One or two or more species of them may be contained. The content may be appropriately determined depending on needed performance and the like.

The N-vinyl cyclic lactam polymer of the present invention has the above-mentioned configuration, and therefore has excellent dispersibility and adsorptivity, and high calcium ion-capturing capability. Therefore, such an N-vinyl cyclic lactam polymer can be preferably used in various applications as well as in detergent additives; dispersants for various inorganic or organic substance; scale inhibitors. Particularly if the polymer is used in a detergent additive application, the polymer can sufficiently prevent migration, redeposition due to clay soil and the like, and thereby exhibit high detergency.

### BEST MODES FOR CARRYING OUT THE INVENTION

The present invention is described in more detail below with reference to Example, but the present invention is not limited to the Example. The term “%” represents “% by weight” unless otherwise specified.

A “K value” of polyvinylpyrrolidone as a raw material was measured by the following way in the following Examples and Comparative Examples. That is, polyvinylpyrrolidone was dissolved in pure water to prepare an aqueous solution containing 1% by weight of pyrrolidone. The aqueous solution was measured for viscosity at 25° C. with a capillary viscosimeter. The measurement value was applied to the following Fikentscher formula to calculate the K value;

(logηᵣₑₗ)/C=[(75Ko²)/(1+1.5Ko C)]+KoK=1000Ko

(C represents the number of grams of the polyvinylpyrrolidone in 100 mL of the solution. ηᵣₑₗ represents the viscosity of the solution to the solvent.)

The higher the K value is, the higher the molecular weight is.

### EXAMPLE 1

Into a polymerization container equipped with a condenser, a nitrogen inlet line, and a thermometer was added polyvinylpyrrolidone (K30) 15 parts by weight and ion exchange water 143.5 parts by weight. The inside of the polymerization container was made to be nitrogen atmosphere by introduction of nitrogen. The polymerization container was heated until the inside temperature was 90° C. Then, while the mixture was stirring, into the mixture was added dropwise a monomer solution, into which acrylic acid 57 parts by weight, 37% sodium acrylate 10.6 parts by weight, and ion exchange water 54.3 parts by weight were mixed, a 15% aqueous solution of ammonium persulfate 12 parts by weight, and 35% sodium hydrogensulfite 7.7 parts by weight over 90 minutes. Then, the mixture was kept stirring under heating at 90° C. for 30 minutes, and into the mixture was added 30% NaOH 26.6 parts by weight to prepare a polymer solution 1.

The obtained polymer solution 1 was measured for viscosity at 25° C. in an aqueous solution with a solid content of 25% by weight, turbidity, calcium ion-capturing capability, and anti-soil redeposition ratio by the above-mentioned methods. Table 1 shows the results.

### COMPARATIVE EXAMPLE 1

Into a polymerization container equipped with a condenser, a nitrogen inlet line, and a thermometer was added polyvinylpyrrolidone (K30) 30 parts by weight and ion exchange water 163.8 parts by weight. The inside of the polymerization container was made to be nitrogen atmosphere by introduction of nitrogen. The polymerization container was heated until the inside temperature was 90° C. Then, while the mixture was stirring, into the mixture was added dropwise a monomer solution, into which acrylic acid 42.8 parts by weight, 37% sodium acrylate 7.9 parts by weight, and ion exchange water 40.7 parts by weight were mixed, a 15% aqueous solution of ammonium persulfate 9 parts by weight, and 35% sodium hydrogensulfite 5.8 parts by weight over 90 minutes. Then, the mixture was kept stirring under heating at 90° C. for 30 minutes, and into the mixture was added 30% NaOH 20 parts by weight to prepare a polymer solution 2.

The obtained polymer solution 2 was measured for viscosity at 25° C. in an aqueous solution with a solid content of 25% by weight, turbidity, calcium ion-capturing capability, and anti-soil redeposition ratio by the above-mentioned methods. Table 1 shows results.

### COMPARATIVE EXAMPLE 2

Into a polymerization container equipped with a condenser, a nitrogen inlet line, and a thermometer was added polyvinylpyrrolidone (K30) 30 parts by weight and ion exchange water 163.8 parts by weight. The inside of the polymerization container was made to be nitrogen atmosphere by introduction of nitrogen. The polymerization container was heated until the inside temperature was 90° C. Then, while the mixture was stirring, a monomer solution, into which acrylic acid 42.8 parts by weight, 37% sodium acrylate 7.9 parts by weight, and ion exchange water 40.7 parts by weight were mixed, and a 15% aqueous solution of ammonium persulfate 9 parts by weight were tried to be added dropwise into the mixture over 90 minutes. However, gelling was generated during the reaction, and therefore a polymer solution could not be prepared.

| | | | Viscosity of solid | | | anti-soil |
|---|---|---|---|---|---|---|
| | PVP/AA | | content of 25% by | | Ca capturing | redeposition |
| | (ratio by | | weight (25° C.) | Turbidity | capability | ratio |
| | weight) | Initiator | (mPa · s) | (mg/l) | (mg-CaCO₃/g) | (%) |
| Example 1 | 100/400 | APS/SBS | 68 | 0.54 | 256 | 66.6 |
| Comparative | 100/150 | APS/SBS | 465 | 0.19 | 220 | 63.9 |
| Example 1 | | | | | | |

| | | | |
|---|---|---|---|
| Comparative | 100/150 | APS | Incapable measurement due to gelling |
| Example 2 | | | |

Descriptions in the above Table 1 are as follows.
“PVP”: Polyvinylpyrrolidone
“AA”: Acrylic acid
“APS”: Ammonium persulfate
“SBS”: Sodium bisulfite

### INDUSTRIAL APPLICABILITY

The N-vinyl cyclic lactam polymer of the present invention has the above-mentioned configuration, and therefore has excellent dispersibility and adsorptivity, and high calcium ion-capturing capability. Therefore, such an N-vinyl cyclic lactam polymer can be preferably used in various applications as well as in detergent additives; dispersants for various inorganic or organic substance; scale inhibitors. Particularly if the polymer is used in a detergent additive application, the polymer can sufficiently prevent migration, redeposition due to clay soil and the like, and thereby exhibit high detergency.

The present application claims priority to Japanese Patent Application No. 2005-156392 filed in Japan on Mar. 27, 2005, entitled “N-CYCLIC VINYL LACTAM POLYMER, PRODUCTION METHOD THEREOF AND APPLICATION THEREOF”, the entire contents of which are herein incorporated by reference.

1. An N-vinyl cyclic lactam polymer produced by a polymerization of a monomer component containing a carboxyl group-containing unsaturated monomer with a polymer having an N-vinyl cyclic lactam unit,
wherein the carboxyl group-containing unsaturated monomer is 200 to 9900 parts by weight, relative to 100 parts by weight of the polymer having an N-vinyl cyclic lactam unit, and the N-vinyl cyclic lactam polymer has a viscosity at 25° C. of 100000 mPa·s or less in an aqueous solution with a solid content of 25% by weight.

2. The N-vinyl cyclic lactam polymer according to claim 1, wherein the N-vinyl cyclic lactam polymer has a calcium-ion capturing capability of 230 mg·CaCo₃/g or more.

3. The N-vinyl cyclic lactam polymer according to claim 1, wherein the N-vinyl cyclic lactam polymer has an anti-soil redeposition ratio of 65.0% or more.

4. A production method of the N-vinyl cyclic lactam polymer of claim 1, wherein the production method comprises a step of performing the polymerization using a peroxide in combination with a chain transfer agent or a reducing agent.

5. The production method of the N-vinyl cyclic lactam polymer according to claim 4,
wherein the polymerization step is a step of using the peroxide in combination with a bisulfite.

6. A detergent additive containing the N-vinyl cyclic lactam polymer of claim 1.

7. A detergent composition containing the detergent additive of claim 6.

8. The N-vinyl cyclic lactam polymer according to claim 2, wherein the N-vinyl cyclic lactam polymer has an anti-soil redeposition ratio of 65.0% or more.

9. A production method of the N-vinyl cyclic lactam polymer of claim 8, wherein the production method comprises a step of performing the polymerization using a peroxide in combination with a chain transfer agent or a reducing agent.

10. A production method of the N-vinyl cyclic lactam polymer of claim 2, wherein the production method comprises a step of performing the polymerization using a peroxide in combination with a chain transfer agent or a reducing agent.

11. A production method of the N-vinyl cyclic lactam polymer of claim 3, wherein the production method comprises a step of performing the polymerization using a peroxide in combination with a chain transfer agent or a reducing agent.

12. A detergent additive containing the N-vinyl cyclic lactam polymer of claim 2.

13. A detergent additive containing the N-vinyl cyclic lactam polymer of claim 3.

14. A detergent additive containing the N-vinyl cyclic lactam polymer of claim 8.

15. The production method of the N-vinyl cyclic lactam polymer according to claim 9, wherein the polymerization step is a step of using the peroxide in combination with a bisulfite.

16. The production method of the N-vinyl cyclic lactam polymer according to claim 10, wherein the polymerization step is a step of using the peroxide in combination with a bisulfite.

17. The production method of the N-vinyl cyclic lactam polymer according to claim 11,
wherein the polymerization step is a step of using the peroxide in combination with a bisulfite.

18. A detergent composition containing the detergent additive of claim 12.

19. A detergent composition containing the detergent additive of claim 13.

20. A detergent composition containing the detergent additive of claim 14.
